(19) United States
(12) Patent Application Publication
(10) Pub. No.: US 2022/0193954 A1
(43) Pub. Date: Jun. 23, 2022

(54) TILE CUTTER WITH WATER GUIDING DEVICE

(71) Applicant: REXON INDUSTRIAL CORP., LTD., Taichung (TW)

(72) Inventor: WAN JIE YOU, Taichung (TW)

(73) Assignee: REXON INDUSTRIAL CORP., LTD., Taichung (TW)

(21) Appl. No.: 17/561,119

(22) Filed: Dec. 23, 2021

(30) Foreign Application Priority Data
Dec. 23, 2020 (TW) 109145783

(51) Int. Cl. B28D 7/02; B28D 1/04

(52) U.S. Cl. CPC B28D 7/02; B28D 1/047

(57) ABSTRACT

A tile cutter with water guiding device includes a base, a work platform slidably set on the base along a front-rear direction and including a top bearing surface for placing the tiles and an accommodating slot set from the top bearing surface toward a bottom surface, a sawing device including a saw blade seat installed in the base and a saw blade installed in the saw blade seat and aligned with the accommodating slot, and a water guiding device detachably installed in the accommodating slot and including two connecting plates spaced apart along a left-right direction perpendicular to the front-rear direction, a plurality of baffle plates arranged at intervals along the front-rear direction and respectively connected to the connecting plates and a plurality of water guide holes defined by a spacing of the connecting plates and the baffle plates. These baffle plates can block the cooling water and prevent splashing, so as to keep the workplace clean.

### BACKGROUND OF THE INVENTION

### 1. Field of the Invention

The present invention relates to tile cutting machines, in particular to a tile cutter with a water guiding device.

### 2. Description of the Related Art

An existing tile cutter is suitable for cutting a tile, and includes a base, a work platform, and a sawing device. The work platform is used for placing the tiles and moving towards the sawing device. The sawing device has a saw blade seat set on the base and a saw blade set on the saw blade seat. When the existing tile cutting machine cuts the tile, it usually sprays cooling water on the saw blade and the tile, in addition to cooling the saw blade, it can also moisten the dust generated during cutting to prevent the dust from flying freely.

Although the existing tile cutter can spray cooling water to prevent the user from inhaling too much dust, the cooling water will be thrown forward by the rotating saw blade to produce splashes. Not only will it wet the ground and cause dirt in the workplace, but also workers are prone to slips and accidents.

### SUMMARY OF THE INVENTION

The present invention has been accomplished under the circumstances in view. It is the main object of the present to provide a tile cutter with water guiding device that can keep the workplace clean and avoid accidents caused by workers slipping.

Therefore, the tile cutter with water guiding device of the present invention is suitable for cutting a tile, and comprises a base, a work platform, a sawing device, and a water guiding device. The base extends along a front-rear direction.

The work platform is slidably installed on the base along a front-rear direction, and comprises a top bearing surface for placing the tile and an accommodating slot arranged from the top bearing surface toward a bottom surface of the work platform and extending along the front-rear direction; The sawing device comprises a saw blade seat located on the base, and a saw blade set on the saw blade seat oriented for cutting along the front-rear direction and located at a top side of the accommodating slot and aligned with the accommodating slot.

The water guiding device is detachably installed in the accommodating slot and comprises two connecting plates spaced apart along a left-right direction perpendicular to the front-rear direction, a plurality of baffle plates arranged at intervals along the front-rear direction and respectively connected to the connecting plates, and a plurality of water guide holes defined by a spacing of the connecting plates and the baffle plates.

The effect of the present invention is that these baffle plates can block cooling water and prevent splashing, can keep the workplace clean, and avoid accidents caused by workers slipping.

### BRIEF DESCRIPTION OF THE DRAWINGS

FIG. 1 is a partial elevational view of a first embodiment of a tile cutter with water guiding device of the present invention.

FIG. 2 is another partial elevational view of the first embodiment.

FIG. 3 is an elevational view of a water guiding device of the first embodiment.

FIG. 4 is a view circle similar to FIG. 3, showing that the water guiding device also has a gap.

FIG. 5 is a cross-sectional schematic circle taken along the v-v line in FIG. 4, showing the state of the water guiding device installed in an accommodating slot.

FIG. 6 is a cross-sectional view taken along the VI-VI line of FIG. 3.

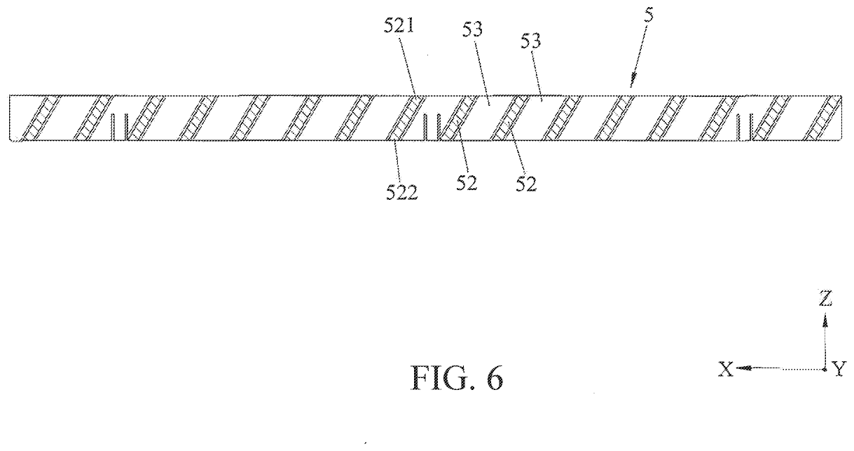

FIG. 7 is a view similar to FIG. 6, showing the state of use of the first embodiment.

FIG. 8 is a view similar to FIG. 6, showing a water guiding device of a second embodiment of the tile cutter with water guiding device of the present invention.

FIG. 9 is a view similar to FIG. 6, showing a water guiding device of a third embodiment of the tile cutter with water guiding device of the present invention.

### DETAILED DESCRIPTION OF THE INVENTION

The present invention will be described in detail below with reference to the drawings and embodiments. Before the present invention is described in detail, attention should be paid to the relative position terms used in the following descriptions, for example, “front-rear direction X”, “left-right direction Y”, “top-bottom direction Z” are based on the orientation shown in each drawing and the normal use orientation, the front-rear direction X, the left-right direction Y, and the top-bottom direction Z are perpendicular to each other. Furthermore, similar components are represented by the same number.

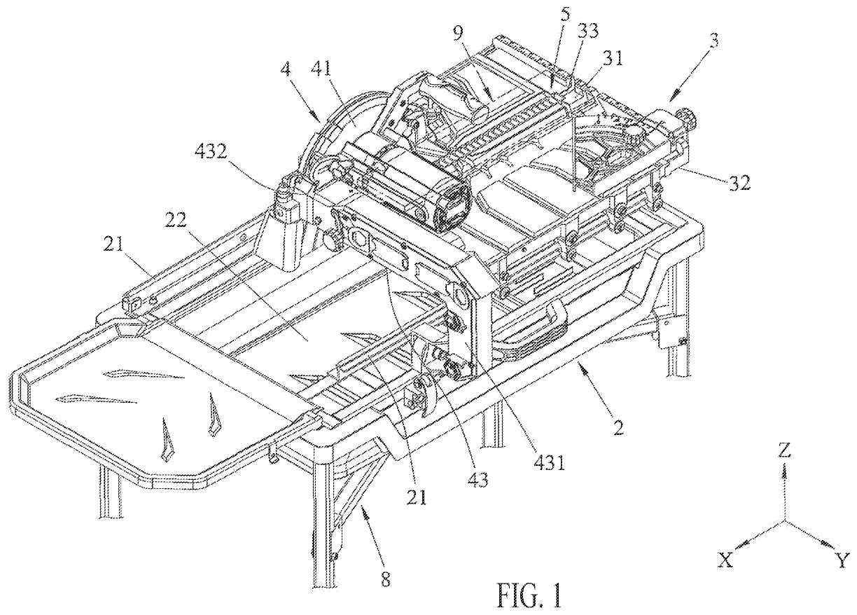

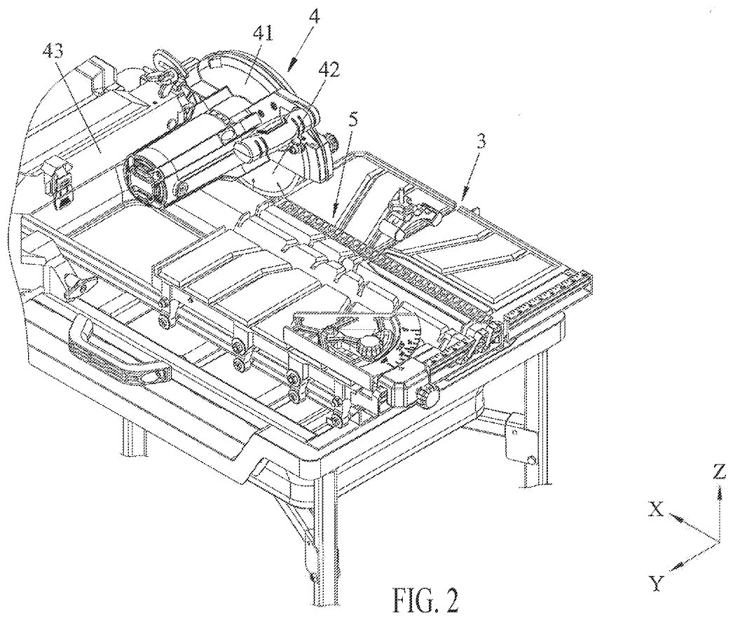

Referring to FIGS. 1-3, a first embodiment of the tile cutter with water guiding device of the present invention is suitable for cutting a tile 9, and comprises a base 2, a work platform 3, a sawing device 4, and a water guiding device 5.

The base 2 is used for supporting and fixing on a stand 8 or a worktable (not shown) and comprises two sliding rails 21 spaced apart along the left-right direction Y and parallel to each other, and a water collection tank 22 located between the sliding rails 21. In this embodiment, the base 2 is erected and fixed on the stand 8.

The work platform 3 can be slidably arranged on the sliding rails 21 along the front-rear direction X, and comprises a top bearing surface 31 for placing the tile 9 on, a bottom surface 32 opposite to the top bearing surface 31 and adjacent to the water collection tank 22, and an accommodating slot 33 that is set from the top bearing surface 31 toward the bottom surface 32 and extends along the front and rear direction X.

The sawing device 4 comprises a saw blade seat 41 that is arranged on the base 2 along the front-rear direction X, and a saw blade 43 arranged on the saw blade seat 42 and positioned at the top of the accommodating slot 33 along the top-bottom direction Z and aligned with the accommodating slot 33. The sawing device 4 also comprises a mounting arm 41. The mounting arm 43 has a fixed section 431 fixed on the left side of the base 2, and a free section 432 bent and extended from the fixed section 431 toward the right side of the base 2, and the saw blade seat 41 is installed on the free section 432.

The water guiding device 5 is detachably installed in the accommodating slot 33 and comprises two connecting plates 51 spaced apart along the left-right direction Y, a plurality of baffle plates 52 arranged at intervals along the front-rear direction X and respectively connected to the connecting plates 51 along the left-right direction Y, and a plurality of water guide holes 53 defined by a spacing of the connecting plates 51 and the baffle plates 52. The water guide holes 53 provide fluid communication from the top bearing surface 31 to the bottom surface 32 and the water collection tank 22. In this embodiment, each baffle plate 52 is arranged obliquely, and has a top portion 521 and a bottom portion 522 that are connected to each other, and the top portion 521 is located on the rear side of the bottom portion 522.

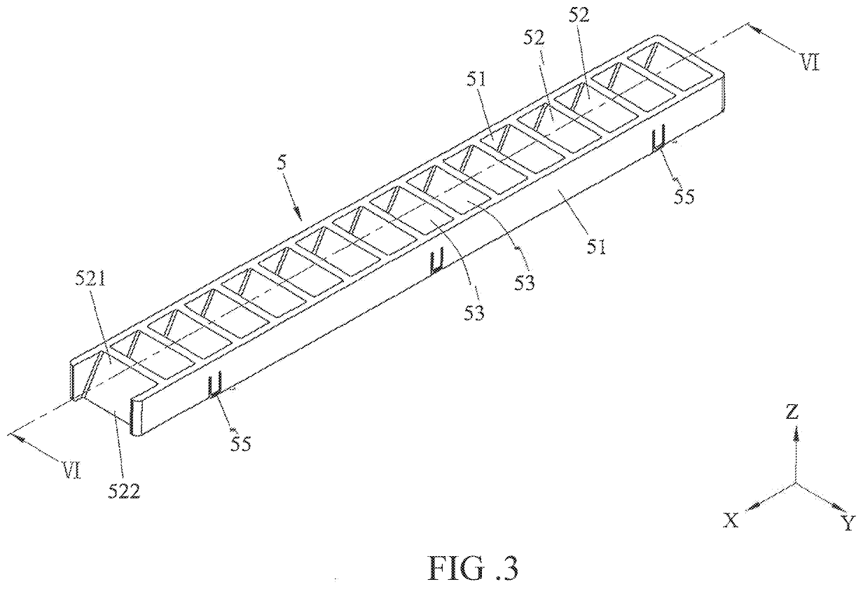

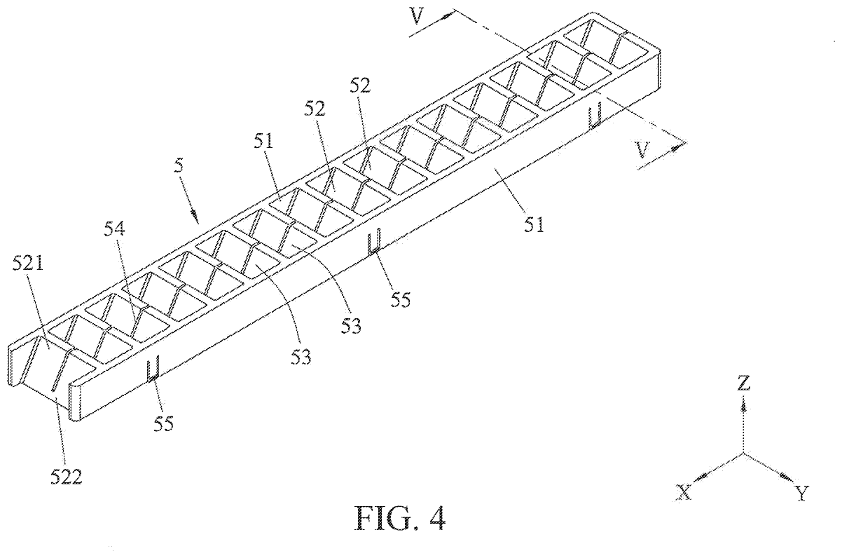

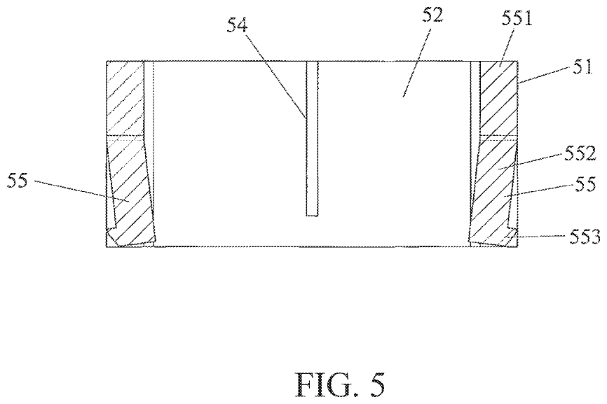

Referring to FIGS. 3-5, the water guiding device 5 also comprises a plurality of snap buttons 55 respectively arranged on the side of the connecting plates 51 and spaced apart from the baffle plates 52. The outer edge of the top side of each snap button 55 is connected to the corresponding connecting plate 51, and two opposite sides are spaced from the connecting plate 51 to form a gap. Each snap button 55 comprises a fixing portion 551 connected to the corresponding connecting plate 51, a free portion 552 connected to the fixing portion 551 and extending downward along the top-bottom direction Z, and an elastic abutment portion 553 disposed at one end of the free portion 552 away from the fixing portion 551 and protruding upward and away from the connecting plate 51. These snap buttons 55 have the characteristics of elastic compression and expansion and can be elastically pressed in the direction of the baffle plates 52 during installation, so that the water guiding device 5 can enter the accommodating slot 33. After entering the accommodating slot 33, the snap buttons 55 are elastically compressed and expanded to force the respective elastic abutment portions 553 against the accommodating slot 33, so that the water guiding device 5 can be firmly installed in the accommodating slot 33, and the position of the water guiding device 5 will not be affected by the cutting process of the tile 9.

It is worth noting that in other implementation aspects, the water guiding device 5 also comprises a gap 54 which is opened between the connecting plates 51 along the front-rear direction X and connects the water guide holes 53. The gap 54 is defined in the baffle plates 52 other than the front baffle plate 52, so that the saw blade 42 can completely cut the tile 9 above the water guiding device 5, and the gap 54 will not affect the water guiding effect. However, it is preferable that the water guiding device 5 has undergone a cutting process of the tile 9 before forming the gap 54 that is set on the baffle plates 52 other than the front baffle plate 52 and opened between the connecting plates 51 along the front-rear direction X and connects the water guide holes 53. The gap 54 can cooperate with the formation of saw blades of different specifications, so that the water guiding device 5 can be applied to tile cutters of various specifications.

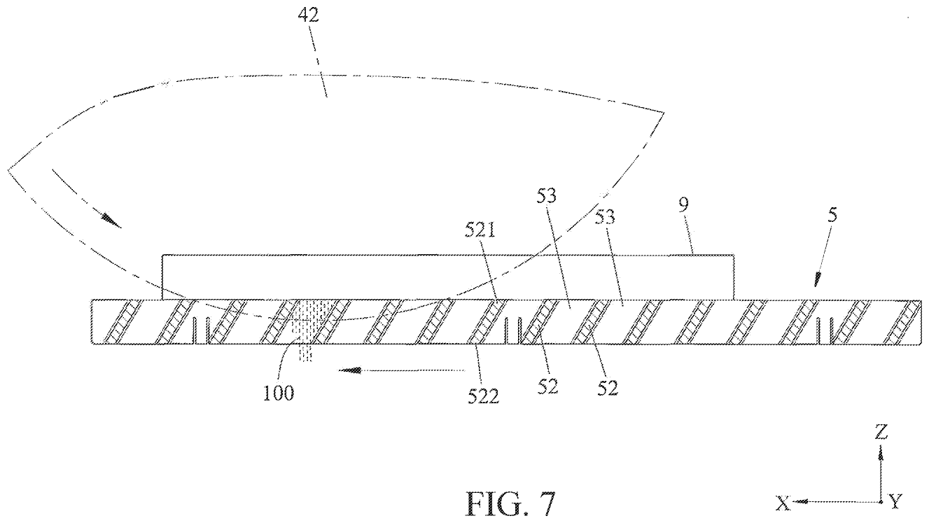

Referring to FIGS. 1 and 7, when in use, place the tile 9 to be cut on the top bearing surface 31 of the work platform 3, and push the work platform 3 forward to move toward the sawing device 4, and then the saw blade 42 is rotated to cut the tile 9 to the appropriate size.

During the cutting process, when the saw blade 42 rotates counterclockwise as shown in FIG. 7, the cooling water 100 will be thrown back by the blade 42. When the saw blade 42 rotates clockwise as shown in FIG. 7, the cooling water 100 will be thrown forward. The present invention uses the baffle plates 52 to play a blocking role, which can effectively prevent the cooling water 100 from splashing, and the cooling water 100 attached to the baffle plates 52 and the cooling water 100 located in the water guide holes 53 can be quickly dropped into the water collection tank 22. In addition, by leaning the bottom portions 522 of the baffle plates 52 forward relative to the top portions 521, the cooling water 100 can be more effectively prevented from splashing.

In summary, in the first embodiment of the tile cutter with water guiding device of the present invention, the baffle plates 52 can block the cooling water 100 being thrown back or forward. It can prevent the cooling water 100 from splashing and can guide the cooling water 100 to flow into the water collection tank 22, so it can indeed achieve the purpose of the invention.

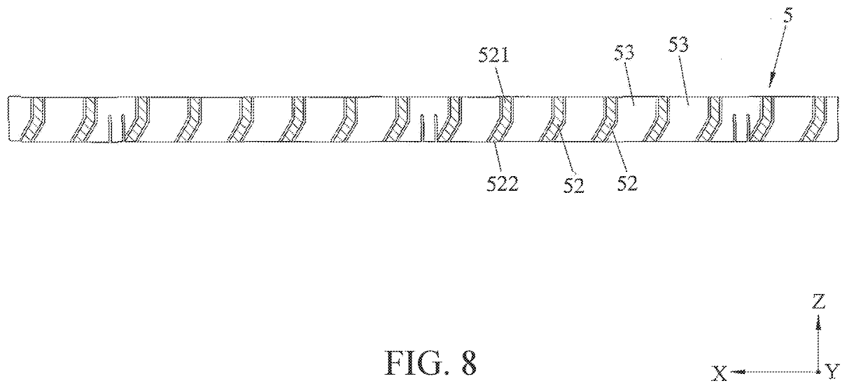

Referring to FIG. 8, a second embodiment of the present invention is similar to the first embodiment, and the difference lies in:

Each baffle plate 52 has a top portion 521 disposed along the top-bottom direction Z, and a bottom portion 522 extending forward from the top portion 521 toward the bottom end.

The second embodiment of the present invention can achieve the same purpose and effect as the first embodiment.

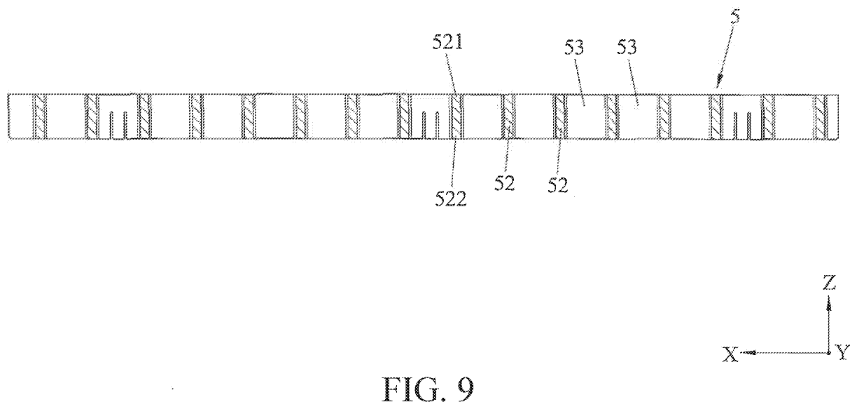

Referring to FIG. 9, a third embodiment of the present invention is similar to the first embodiment, and the difference lies in:

The top portion 521 and bottom portion 522 of each baffle plate 52 extend along the top-bottom direction Z.

This third embodiment of the present invention can achieve the purpose and effect of the present invention.

However, the above are only examples of the present invention, and should not be used to limit the scope of implementation of the present invention. All simple equivalent changes and modifications made according to the scope of the patent application of the present invention and the content of the patent specification are still within the scope of the patent of the present invention.

What is claimed is:

1. A tile cutter with water guiding device, suitable for cutting a tile, comprising:
a base,
a work platform slidably installed on said base along a front-rear direction, said work platform comprising a top bearing surface for placing said tile and an accommodating slot arranged from said top bearing surface toward a bottom surface of said work platform and extending along said front-rear direction;
a sawing device comprising a saw blade seat located on said base, and a saw blade set on said saw blade seat oriented for cutting along said front-rear direction and located at a top side of said accommodating slot and aligned with said accommodating slot; and
a water guiding device detachably installed in said accommodating slot, said water guiding device comprising two connecting plates arranged spaced apart along a left-right direction perpendicular to said front-rear direction, a plurality of baffle plates arranged at intervals along said front-rear direction and respectively connected to said connecting plates, and a plurality of water guide holes defined by a spacing of said connecting plates and said baffle plates.

2. The tile cutter with water guiding device as claimed in claim 1, wherein each said baffle plate is arranged obliquely and comprises a top portion and a bottom portion, said top portion being located on a back side of said bottom portion.

3. The tile cutter with water guiding device as claimed in claim 1, wherein each said baffle plate comprises a top portion arranged along a top-bottom direction perpendicular to said front-rear direction, and a bottom portion extending forward from said top portion toward a bottom end.

4. The tile cutter with water guiding device as claimed in claim 1, wherein each said baffle plate extends along a top-bottom direction perpendicular to said front-rear direction.

5. The tile cutter with water guiding device as claimed in claim 1, wherein said water guiding device also comprises a gap which is opened between the connecting plates along the front-rear direction and connects the water guide holes, said gap being defined in said baffle plates other than the said baffle plate at the front side.

6. The tile cutter with water guiding device as claimed in claim 1, wherein said water guiding device also comprises a plurality of snap buttons respectively arranged on the side of said connecting plates and spaced apart from said baffle plates, each said snap button having an outer edge thereof connected to the corresponding said connecting plate and two opposite sides thereof spaced from the corresponding said connecting plate to form a gap, each said snap button comprising a fixing portion connected to the corresponding said connecting plate, a free portion connected to said fixing portion and extending downward along said top-bottom direction and an elastic abutment portion disposed at one end of said free portion away from said fixing portion and protruding upward and away from said connecting plate.
